(19) United States
(12) Patent Application Publication
(10) Pub. No.: US 2024/0120659 A1
(43) Pub. Date: Apr. 11, 2024

(54) AUTO-CORRECTION OF ANTENNA GEOMETRY USING METAMATERIALS

(71) Applicant: Dell Products L.P., Round Rock, TX (US)

(72) Inventors: Ofir Ezrielev, Be'er Sheva (IL); Jehuda Shemer, Kfar Saba (IL); Ronen Rabani, Kibuts Telalim (IL); Avitan Gefen, Tel Aviv (IL)

(21) Appl. No.: 17/936,633

(22) Filed: Sep. 29, 2022

(51) Int. Cl. H01Q 15/00; H01Q 1/24; H01Q 1/42; H01Q 19/06; H01Q 21/06

(52) U.S. Cl. CPC H01Q 15/006; H01Q 1/243; H01Q 1/42; H01Q 19/06; H01Q 21/065

(57) ABSTRACT

A system can comprise a communications antenna comprising a material that is configured to change shape in response to being stimulated with an external stimulus. The system can comprise an antenna performance detector that is configured to detect a measure of performance of the communications antenna. The system can comprise a distortion correction component that is configured to receive an indication of the measure of performance, determine an amount of distortion of the shape of the communications antenna based on the indication of the measure of performance, based on the amount of distortion, determine an amount of the external stimulus with which to stimulate the communications antenna, and selectively apply the amount of the external stimulus to the communications antenna to change the shape of the communications antenna.

### BACKGROUND

Radio antennas can be used to transmit and receive signals. Dimensions of a radio antenna can affect that antenna's performance.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can comprise a communications antenna comprising a material that is configured to change shape in response to being stimulated with an external stimulus. The system can comprise an antenna performance detector that is configured to detect a measure of performance of the communications antenna. The system can comprise a distortion correction component that is configured to receive an indication of the measure of performance, determine an amount of distortion of the shape of the communications antenna based on the indication of the measure of performance, based on the amount of distortion, determine an amount of the external stimulus with which to stimulate the communications antenna, and selectively apply the amount of the external stimulus to the communications antenna to change the shape of the communications antenna.

An example method can comprise detecting, by a system comprising a processor, a measure of performance of an antenna. The method can further comprise determining, by the system, an amount of an external stimulus with which to stimulate the antenna based on the measure of performance. The method can further comprise stimulating, by the system, the antenna with the amount of the external stimulus.

An example non-transitory computer-readable medium can comprise instructions that, in response to execution, cause a system comprising a processor to perform operations. These operations can comprise determining a performance of an antenna, wherein a shape of the antenna changes shape in response to application of a stimulus to the antenna. The operations can further comprise determining an amount of the stimulus to apply to the antenna based on the performance. The operations can further comprise applying the amount of the stimulus to the antenna.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate auto-correction of antenna geometry using metamaterials, in accordance with an embodiment of this disclosure;

FIG. 2 illustrates another example system architecture that can facilitate auto-correction of antenna geometry using metamaterials, in accordance with an embodiment of this disclosure;

FIG. 3 illustrates another example system architecture that can facilitate auto-correction of antenna geometry using metamaterials, in accordance with an embodiment of this disclosure;

FIG. 4 illustrates another example system architecture that can facilitate auto-correction of antenna geometry using metamaterials, in accordance with an embodiment of this disclosure;

FIG. 5 illustrates another example system architecture that can facilitate auto-correction of antenna geometry using metamaterials, in accordance with an embodiment of this disclosure;

FIG. 6 illustrates another example system architecture that can facilitate auto-correction of antenna geometry using metamaterials, in accordance with an embodiment of this disclosure;

FIG. 7 illustrates an example process flow that can facilitate auto-correction of antenna geometry using metamaterials, in accordance with an embodiment of this disclosure;

FIG. 13 illustrates another example process flow that can facilitate auto-correction of antenna geometry using metamaterials, in accordance with an embodiment of this disclosure;

FIG. 9 illustrates another example process flow that can facilitate auto-correction of antenna geometry using metamaterials, in accordance with an embodiment of this disclosure;

FIG. 10 illustrates another example process flow that can facilitate auto-correction of antenna geometry using metamaterials, in accordance with an embodiment of this disclosure;

FIG. 11 illustrates another example process flow that can facilitate auto-correction of antenna geometry using metamaterials, in accordance with an embodiment of this disclosure;

FIG. 12 illustrates another example process flow that can facilitate auto-correction of antenna geometry using metamaterials, in accordance with an embodiment of this disclosure;

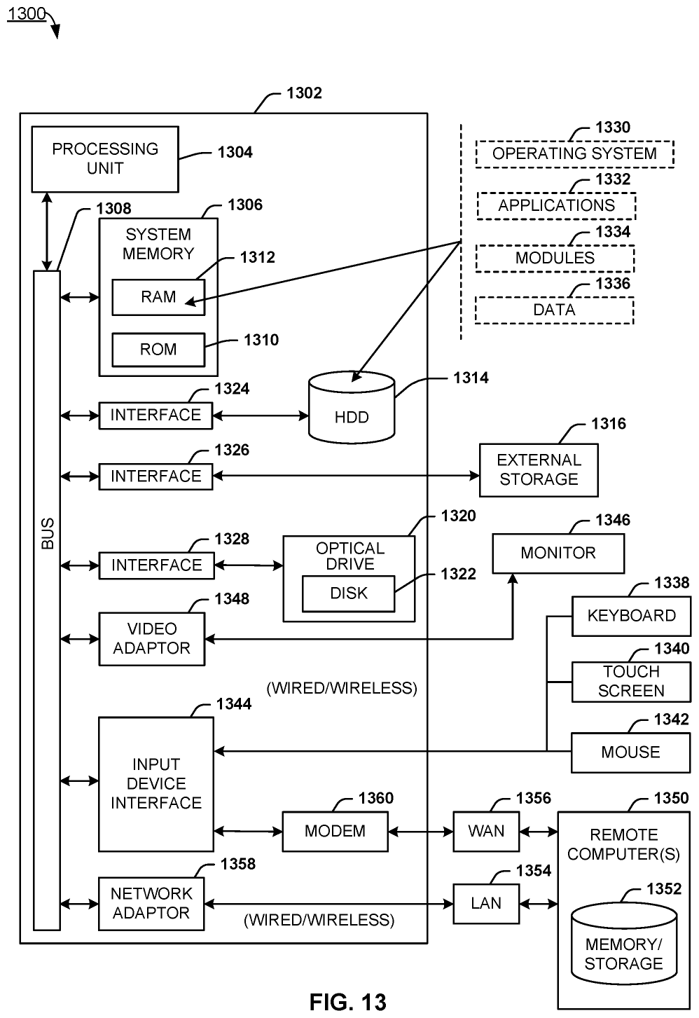

FIG. 13 illustrates an example block diagram of a computer operable to execute an embodiment of this disclosure.

### DETAILED DESCRIPTION

### Overview

While the examples herein primarily concern fifth-generation broadband cellular communications (5G) antennae, it can be appreciated that the present techniques can more generally be applied to other types of antennae.

It can be that are located in a harsh physical environment, such as one where they are subject to temperatures that range from −40 to +100 Celsius (C). This temperature fluctuation can distort a geometry of the antenna, which in turn can affect a key performance indicator (KPI) of the antenna, and reduce the antenna's reception and transmission. In prior approaches, this issue can be mitigated by adding power to the antenna when a downgrade in the KPI is detected.

A problem with these prior approaches can that an increase in power consumption by the antenna can cause different problems, such as excessive power consumption, overheating, increased size, and additional interference.

The present techniques can be implemented to better address distortions in antenna geometry. The present techniques can be implemented to take advantage of shape shifting materials to restore a geometry of an antenna. These materials can include materials such as bilayer materials, and/or programmable materials. The present techniques can also be implemented to use excess heat from a radio unit (RU) heat sink as an energy source for stimuli, which can reduce an overall power consumption, and provide an energy-efficient approach. In contrast to approaches that use electric stimuli to heat, in the present techniques heat can be reused, thus maintaining a better energetic signature.

A shape optimizer module can receive as inputs environmental conditions and an antenna decibel (dB) output, and output a stimuli to change an antenna shape to improve (or restore optimum) antenna performance.

5G antennae can be located in a physical hostile environment and exposed to extreme temperatures that can cause a decrease in a 5G antenna's gain. 5G deployments can use many more base stations and RUs than former generations like fourth-generation broadband cellular communications (4G) technologies, so the issue can more acute in a 5G scenario, and there can be more benefits in addressing these problems in a 5G scenario.

In prior approaches, a way to mitigate antenna distortion can be by using more power when a temperature associated with the antenna deviates from a normal temperature, and to compensate for gain loss. Another prior approach can be to add more RUs. Both approaches can be expensive, and require infrastructure to implement.

A problem with adding power is that it can change a heating signature and power consumption of a RU. A problem with adding infrastructure can be expensive, if it is even possible due to environmental constraints.

The present techniques can be implemented with bilayer materials. A bilayer material (e.g., a material comprising two different materials that are joined together into a bilayer construct) can be configured to generate bending movements under certain conditions. A swelling/shrinking mismatch between the two layers in response to activation stimuli (e.g., heat) can occur, while sustaining a same strain at an interface between the layers, which can result in different types of deformation.

Prior approaches generally implement bilayer materials to correct heat differences (e.g., in thermostats), rather than as a tool to correct geometry.

With regard to bilayer materials, it can be that a bilayer made of two materials with different thermal expansion coefficients can result in a uniform curvature, which is inversely proportional to its thickness. A normalized curvature of a bilayer material can be expressed as:

$$\tilde{κ} = \frac{κ h}{Δ α} = \frac{6 {( 1 + m )}^{2}}{3 {( 1 + m )}^{2} + ( 1 + mn ) ( {m}^{2} + \frac{1}{mn} )}$$

where κ is a bilayer curvature, h is a thickness of the material, Δα is a mismatch in the thermal expansion coefficients of the two layers, n is a stiffness ratio of both layers, and m is a thickness ratio of both layers.

In some examples of the present techniques, ranges for h can be from 0.5 to 1.5 millimeters (about 0.06 inches), ranges for κ can be between 0.1 to 0.5 millimeters (about 0.02 inches), and the curvature of κ *h/Δα can be between 0.0 to 1.5 millimeters.

These dimensions can fit well in the range of a 5G multiple-input and multiple-output (MIMO) antenna.

Given this, in some examples, an application of even slight heat differences can be enough to influence a geometry of a 5G antenna. That is, the environment can change a geometry of an antenna via heat, and the present techniques can also be implemented to change a geometry of the antenna via heat.

A problem with antennas can be that environmental factors can distort antenna geometry; that a distortion can reduce antenna efficiency and harm reception; that where additional power is used to compensate for degradation, energy can be wasted while unit size and interference can be correspondingly increased; and that this problem can become more significant as more antennas are deployed, such as with 5G systems compared to 4G systems.

In some examples, the present techniques can be implemented as a two-part system. One part can comprise a module to detect a decrease in an antenna KPI, and reduced performance (which can be referred to as an antenna KPI detector). Another part can comprise a module that corrects a distortion caused by environmental pressure, e.g., temperature, humidity, and/or minor trauma (which can be referred to as a distortion correction module).

An antenna KPI detector can be responsible for monitoring a throughput of the antenna at both receiving and transmitting ends. Where the antenna KPI detector detects a downgrade in the KPI it will trigger a request for a distortion correction module (DCM) to act and attempt to correct the antenna topology.

In some examples, the antenna KPI detector can be configured to detect antenna KPIs in a variety of ways: detection of changes in the antenna; detection of changes of physical attributes or geometry of the antenna; measurement of the environment (temperature, etc.) and derivation of impacts on the antenna; etc. In some examples, combinations of detecting approaches can be implemented.

In some examples, once a detection has been performed, the antenna KPI detector can derive a change in performance, and can issue alerts (e.g., to the distortion correction module) regarding changes above a certain threshold, and for which a correction can be performed.

A distortion correction module can be configured to receive an alert or trigger from the antenna KPI detector in response to the antenna KPI detector detecting a downgrade in antenna performance, and/or a temperature read. The distortion correction module can attempt to fix the distortion in the antenna by implementing a multilayers bending technique.

Using the above equation, it can be that the distortion correction module is configured to increase a value of k toward 1. In some examples, the distortion correction module can be configured to increase the value of k as close to 1 as possible. The distortion correction module can accomplish this by outputting a correction pulse, which can heat an antenna layer depending on Ja (the mismatch in the thermal expansion coefficients) to get the antenna to bend in an intended direction. In some examples, antenna curvature can be related to a ratio or difference in a temperature of the bilayer material, so that this correction technique can be applied regardless of an absolute temperature outside.

In some examples, using electricity to heat an antenna can be wasteful. To mitigate overall power consumption of an antenna system, a heat sink of a DU can be used as a heat source for heat pulses that the distortion correction module can use to oversee a distribution of heat to a matrix material in the antenna. That is, excess heat that is already present in the system can be channeled to particular areas in the antenna. In some examples, this can be effectuated by connecting heat conducting strips or wires (e.g., a metal, ceramic, and/or composite material), to the radio heat sink, and using the strips or wires to conduct the heat to a particular area on the antenna. A set of electronic switches that connect or disconnect each of these strips or wires can be controlled, which can thus select where heat is dispensed on the antenna. In some examples, controlling switches can be energy efficient.

The present techniques can be implemented to facilitate auto-correction of antenna geometry using metamaterials. That is, metamaterials can be used to create an antenna where the geometrical properties of the antenna can be altered. In some examples, metamaterials can be used in creating an antenna to alter a receiver and/or transmitter to fit a specific wavelength.

The present techniques can be implemented to facilitate a reuse of excessive heat to reshape an antenna geometry. Rather than dumping excessive heat generated by a DU to a heat sink, the present techniques can be implemented to harness the heat and use it as a stimulus to metamaterials in an antenna. With this approach, it can be that an overall power consumption of a system remains almost unchanged while implementing the present techniques.

The present techniques can be implemented to reduce power consumption. That is, they can be implemented to reduce a need to mitigate antenna signal degradation with more power or more DUs.

The present techniques can be implemented to improve DU power consumption. That is, DUs can have features to reduce power consumption, and the present techniques can be implemented to offer an additional technique in doing so.

The present techniques can be implemented to offer dynamic antenna characteristics. A programmable antenna according to the present techniques can possess dynamic characteristics, which can be optimized to receive different wavelengths, and thus decrease a possibility of signal loss. That is, signal loss can be mitigated or avoided by altering an antenna to receive a particular signal.

### Example Architectures

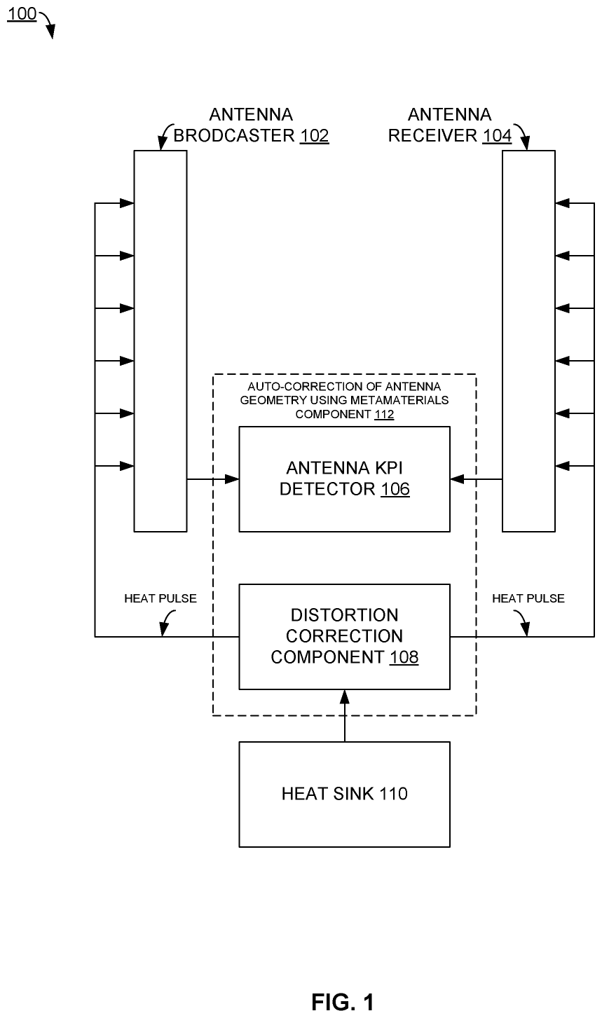

FIG. 1 illustrates an example system architecture 100 that can facilitate auto-correction of antenna geometry using metamaterials, in accordance with an embodiment of this disclosure.

System architecture 100 comprises antenna broadcaster 102, antenna receiver 104, antenna KPI detector 106, distortion correction component 108, and heat sink 110. Antenna broadcaster 102 can comprise a communications antenna that is configured to transmit wireless communications to another device. Antenna receiver 104 can comprise a component that is configured to receive wireless communications from another device.

Antenna KPI detector 106 can comprise a component that is configured to detect a decrease in a KPI (and reduced performance) of antenna broadcaster 102 and/or antenna receiver 104. Distortion correction component 108 can comprise a component that is configured to receive a signal from antenna KPI detector that antenna broadcaster 102 and/or antenna receiver 104 is experiencing reduced performance, determine an amount of heat energy to apply to antenna broadcaster 102 and/or antenna receiver 104 to change its shape to improve its performance, and apply that heat energy. In some examples, distortion correction component 108 is configured to selectively apply heat energy to one or more locations on antenna broadcaster 102 and/or antenna receiver 104.

While examples herein generally describe heat energy, it can be appreciated that the present techniques can be used to apply an external stimulus to antenna broadcaster 102 and/or antenna receiver 104 to change a shape of antenna broadcaster 102 and/or antenna receiver 104.

Together, antenna KPI detector 106 and distortion correction component 108 can be referred to as auto-correction of antenna geometry using metamaterials component 112.

Heat sink 110 can comprise a component configured to draw away heat from other parts of system architecture 100. In some examples, distortion correction component 108 can use heat gathered by heat sink as a heat pulse provided to antenna broadcaster 102 and/or antenna receiver 104.

Each of antenna KPI detector 106 and/or distortion correction component 108 can be implemented with part(s) of computing environment 1300 of FIG. 13.

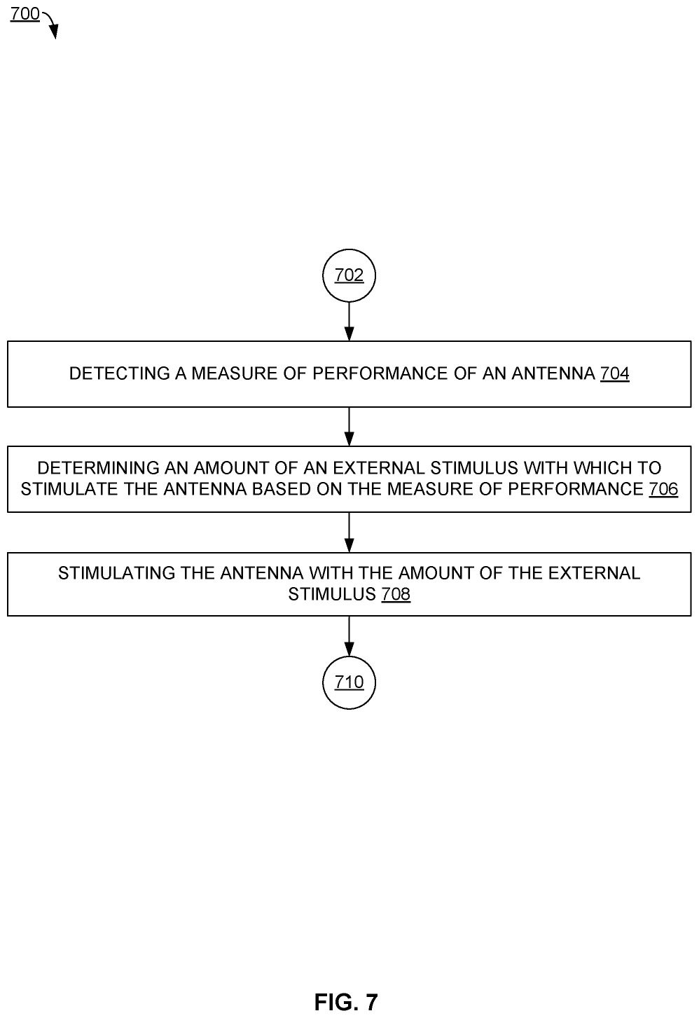

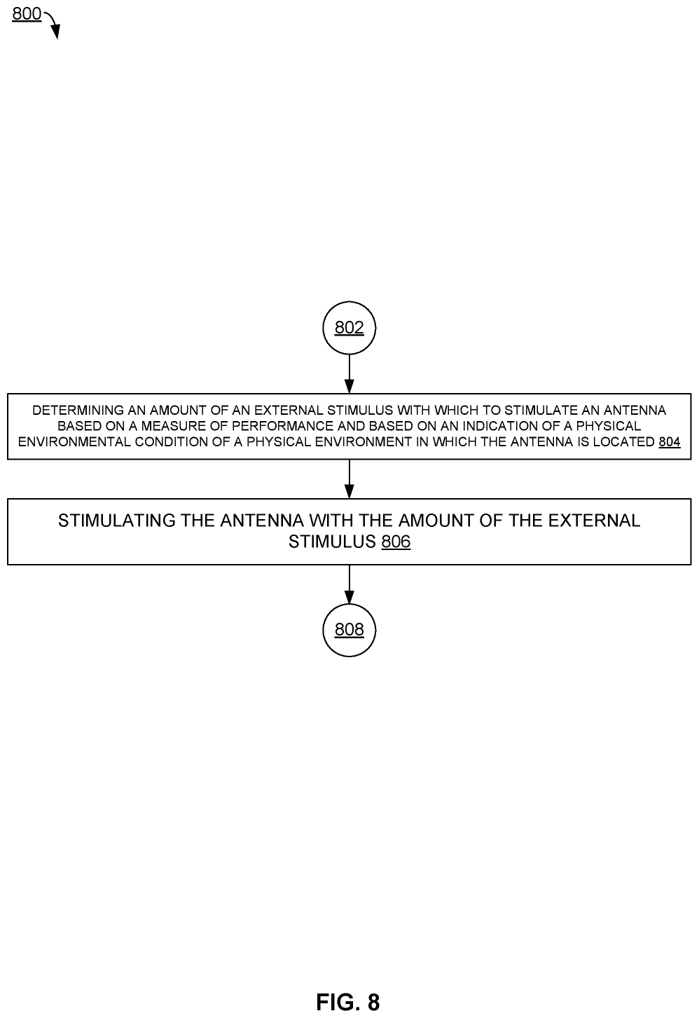

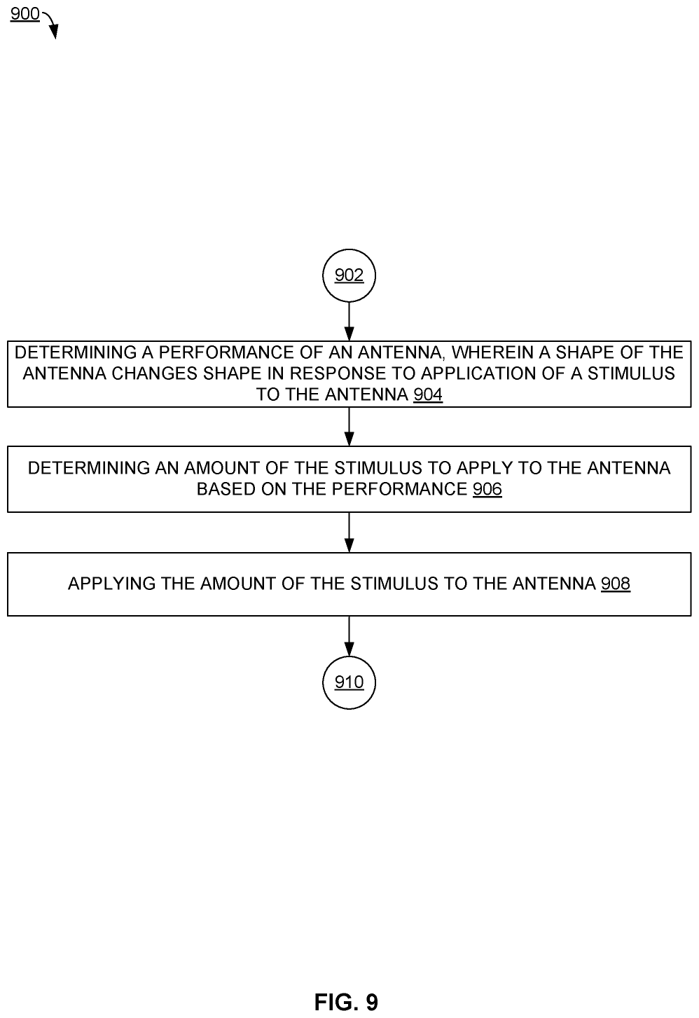

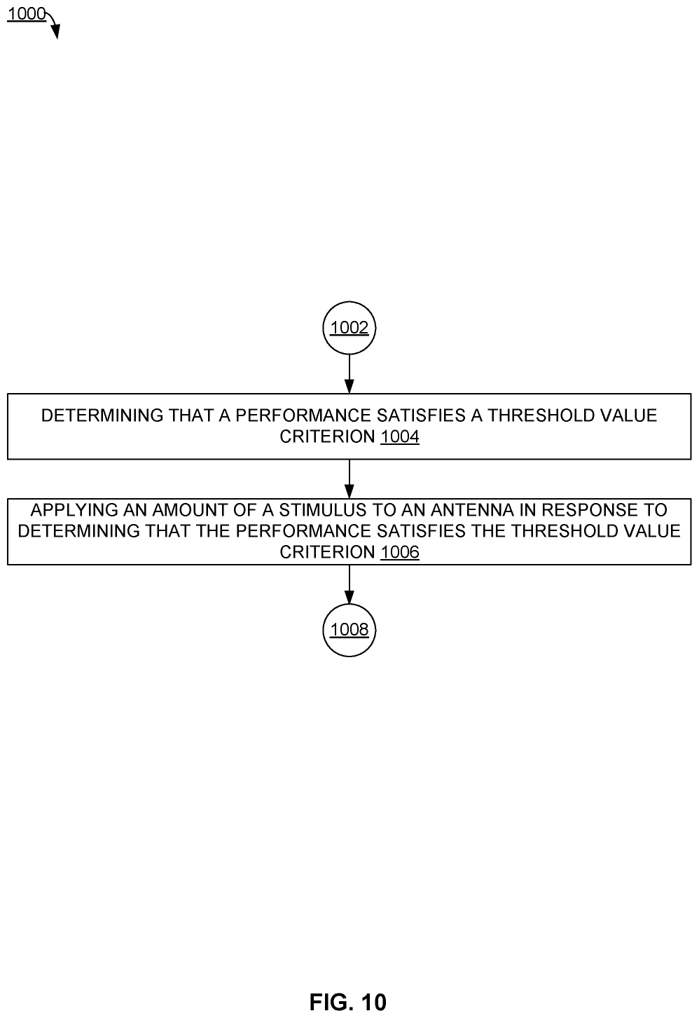

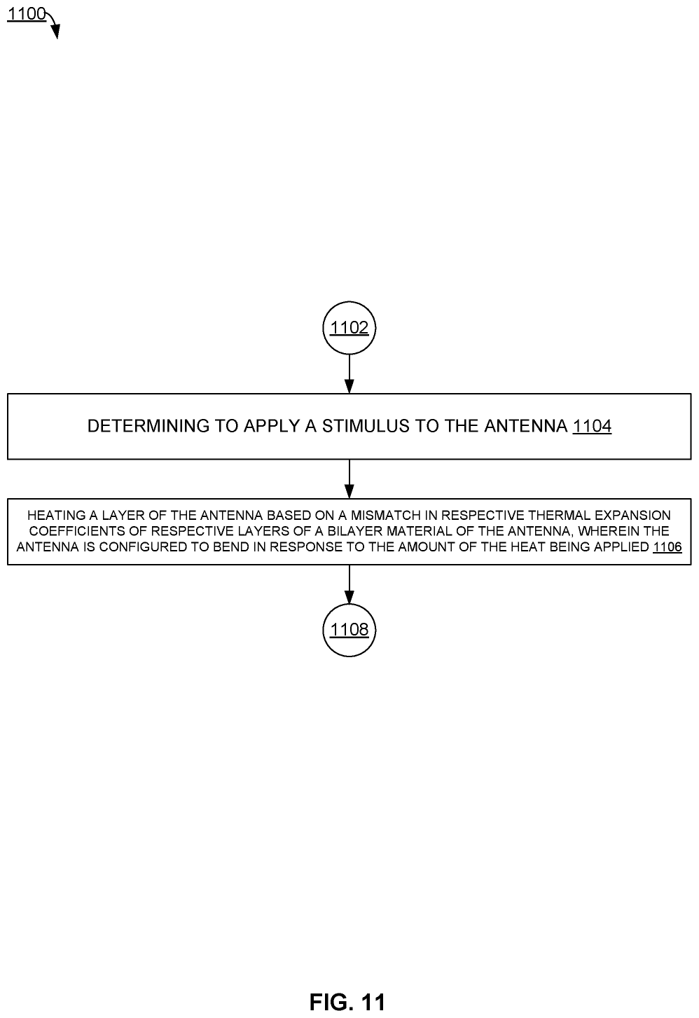

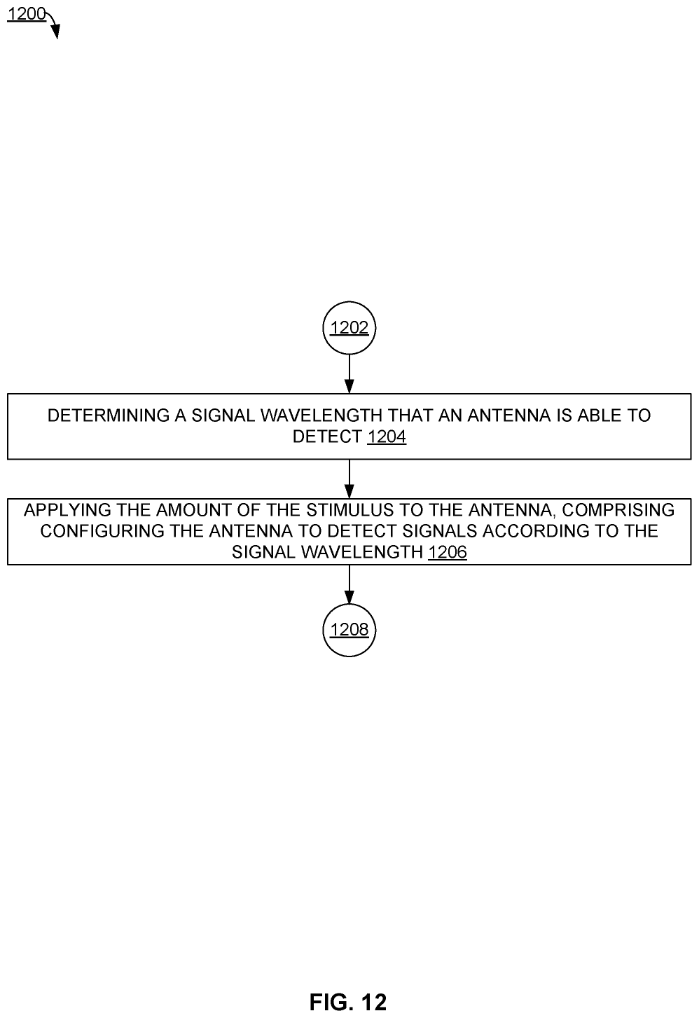

In some examples, auto-correction of antenna geometry using metamaterials component 112 can implement part(s) of the process flows of FIGS. 7-12 to facilitate auto-correction of antenna geometry using metamaterials.

It can be appreciated that system architecture 100 is one example system architecture for auto-correction of antenna geometry using metamaterials, and that there can be other system architectures that facilitate auto-correction of antenna geometry using metamaterials.

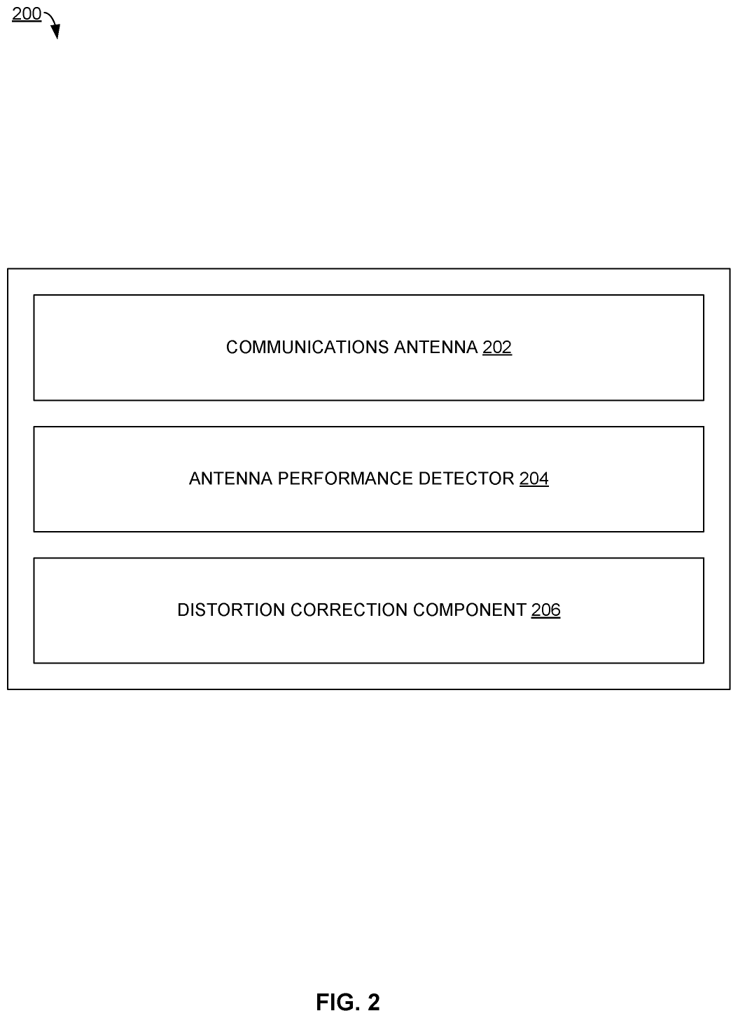

FIG. 2 illustrates another example system architecture 200 that can facilitate auto-correction of antenna geometry using metamaterials, in accordance with an embodiment of this disclosure. In some examples, part(s) of system architecture 200 can be used to implement part(s) of system architecture 100 of FIG. 1.

System architecture 200 comprises communications antenna 202, antenna performance detector 204, and distortion correction component 206. In some examples, communications antenna 202 can comprise a material that is configured to change shape in response to being stimulated with an external stimulus. In some examples, antenna performance detector 204 is configured to detect a measure of performance of communications antenna 202.

In some examples, distortion correction component 206 is configured to receive an indication of the measure of performance, determine an amount of distortion of the shape of the communications antenna based on the indication of the measure of performance, based on the amount of distortion, determine an amount of the external stimulus with which to stimulate the communications antenna, and selectively apply the amount of the external stimulus to the communications antenna to change the shape of the communications antenna.

In some examples, communications antenna 202 comprises a bilayer material, and changing the shape of the communications antenna comprises changing a bilayer curvature of the communications antenna. That is, changing an antenna's shape can comprise changing its bilayer curvature (κ).

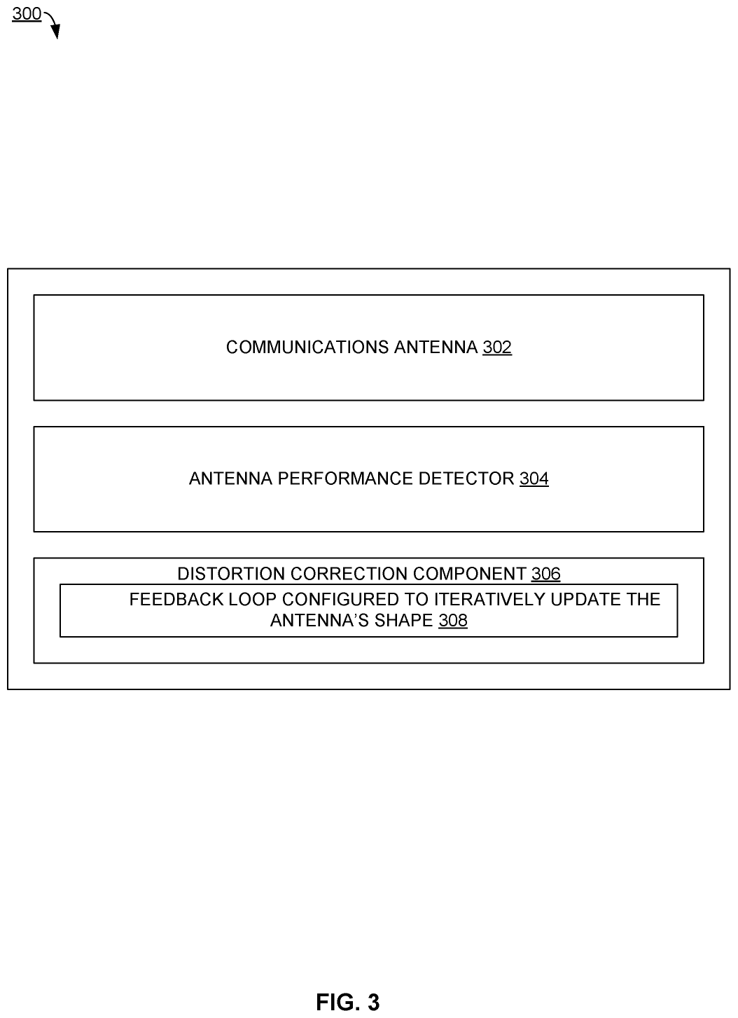

FIG. 3 illustrates another example system architecture 300 that can facilitate auto-correction of antenna geometry using metamaterials, in accordance with an embodiment of this disclosure. In some examples, part(s) of system architecture 300 can be used to implement part(s) of system architecture 100 of FIG. 1.

System architecture 300 comprises communications antenna 302 (which can be similar to communications antenna 202 of FIG. 2), antenna performance detector 304 (which can be similar to antenna performance detector 204), distortion correction component 306 (which can be similar to distortion correction component 206), and feedback loop configured to iteratively update the antenna's shape 308.

Using the example of system architecture 200 of FIG. 2, it can be that the indication of the measure of performance is a first indication of a first measure of performance, selectively applying the amount of the external stimulus to the communications antenna to change the shape of the communications antenna produces a first antenna shape, the amount of distortion is a first amount of distortion, and the amount of the external stimulus is a first amount of the external stimulus.

In such examples, feedback loop configured to iteratively update the antenna's shape 308 can be configured to receive a second indication of a second measure of performance, the second measure of performance being based on the first indication of the first measure of performance, determine a second amount of distortion of the first antenna shape of the communications antenna based on the second indication of the second measure of performance, based on the second amount of distortion, determine a second amount of the external stimulus with which to stimulate the communications antenna, and selectively apply the second amount of the external stimulus to the communications antenna to change the shape of the communications antenna from the first antenna shape to a second antenna shape. That is, a feedback loop can be implemented to iteratively update a shape of communications antenna 302.

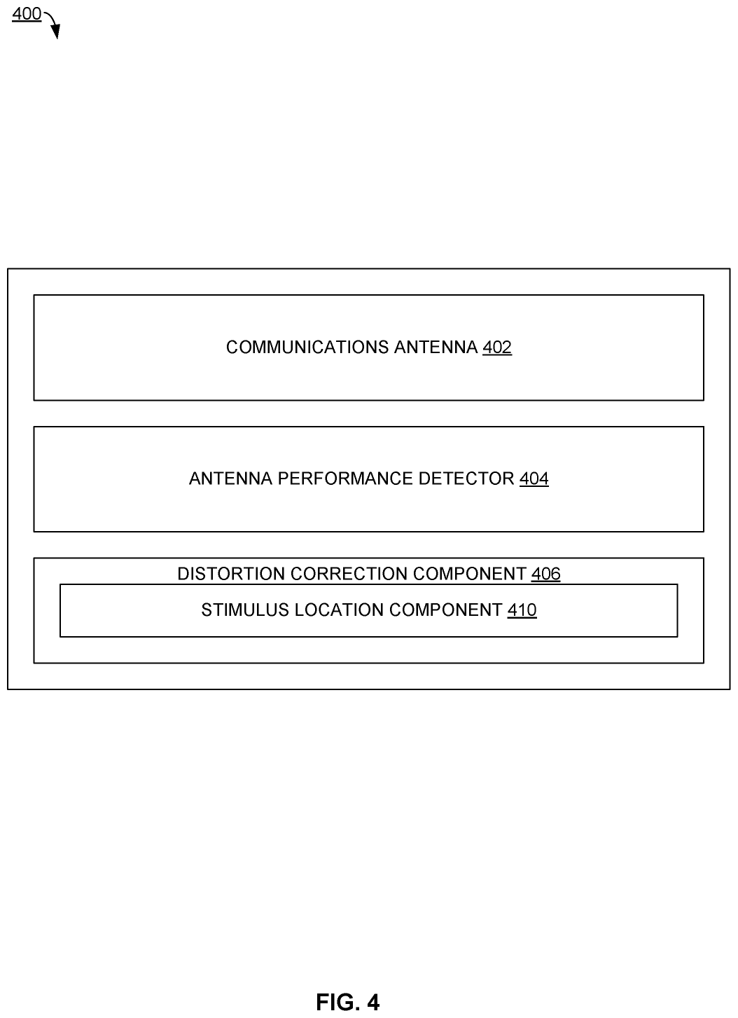

FIG. 4 illustrates another example system architecture 400 that can facilitate auto-correction of antenna geometry using metamaterials, in accordance with an embodiment of this disclosure. In some examples, part(s) of system architecture 400 can be used to implement part(s) of system architecture 100 of FIG. 1.

System architecture 400 comprises communications antenna 402 (which can be similar to communications antenna 202 of FIG. 2), antenna performance detector 404 (which can be similar to antenna performance detector 204), distortion correction component 406 (which can be similar to distortion correction component 206), and stimulus location component 410.

Stimulus location component 410 can be configured to stimulate respective locations of a group of locations of the communications antenna with the amount of the external stimulus, select a location of the group of locations based on the indication of the measure of performance, and stimulate the communications antenna with the amount of the external stimulus at the location. That is, the external stimulus can be applied to different parts of communications antenna 402 to change its shape in different ways.

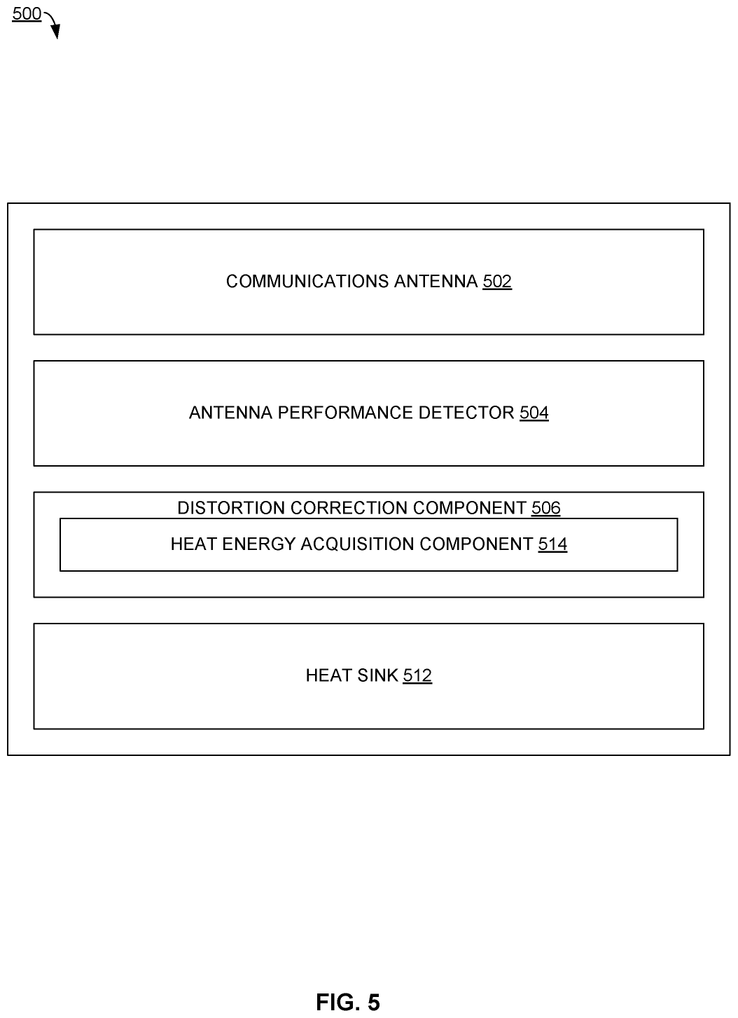

FIG. 5 illustrates another example system architecture 500 that can facilitate auto-correction of antenna geometry using metamaterials, in accordance with an embodiment of this disclosure. In some examples, part(s) of system architecture 500 can be used to implement part(s) of system architecture 100 of FIG. 1.

System architecture 500 comprises communications antenna 502 (which can be similar to communications antenna 202 of FIG. 2), antenna performance detector 504 (which can be similar to antenna performance detector 204), distortion correction component 506 (which can be similar to distortion correction component 206), heat sink 512, and heat energy acquisition component 514.

Heat sink 512 can comprise a component configured to draw away heat from other parts of system architecture 500. In some examples, heat sink 512 can comprise a heat sink of a distributed unit of a radio that is communicatively coupled to communications antenna 502.

Heat energy acquisition component 514 can be configured to use heat from heat sink 512 as the external stimulus to the antenna. In this context, the external stimulus can be referred to as external to contrast it to a stimulus of a signal that is received at communications antenna 502 or that is generated for transmission by communications antenna 502. In some examples, heat energy acquisition component 514 is configured to acquire the amount of heat energy used by distortion correction component 506 used to change the shape of communications antenna 502 from the heat sink.

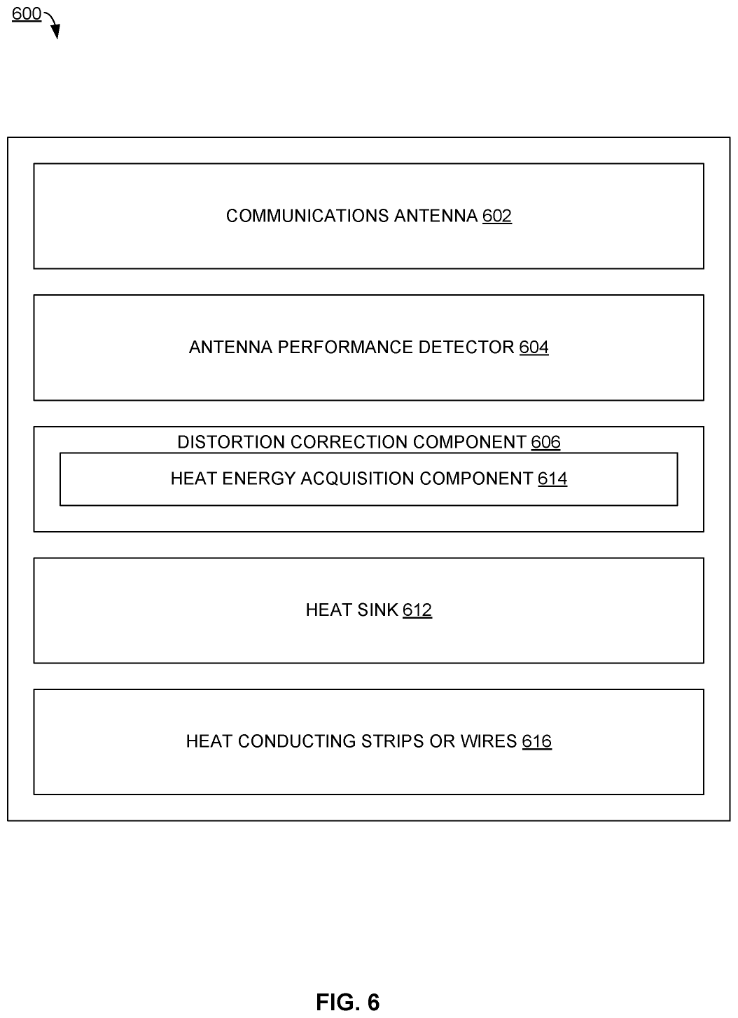

FIG. 6 illustrates another example system architecture 600 that can facilitate auto-correction of antenna geometry using metamaterials, in accordance with an embodiment of this disclosure. In some examples, part(s) of system architecture 600 can be used to implement part(s) of system architecture 100 of FIG. 1.

System architecture 600 comprises communications antenna 602 (which can be similar to communications antenna 202 of FIG. 2), antenna performance detector 604 (which can be similar to antenna performance detector 204), distortion correction component 606 (which can be similar to distortion correction component 206), heat sink 612 (which can be similar to heat sink 512 of FIG. 5), heat energy acquisition component 614 (which can be similar to heat energy acquisition component 514), and heat conducting strips or wires 616.

Heat conducting strips or wires 616 can comprise a group of heat conducting strips or wires coupled to heat sink 612, where respective heat conducting strips or wires of heat conducting strips or wires 616 are configured to carry the heat energy from heat sink 612 to respective locations on communications antenna 602. That is, there can be multiple strips or wires from a heat sink to different spots on an antenna;

In some examples, heat conducting strips or wires 616 comprises a group of electronic switches, where respective electronic switches of the group of electronic switches are configured to selectively control whether the respective heat conducting strips or wires carry the heat energy from heat sink 612 to the respective locations on communications antenna 602. That is, there can be electronic switches that control the flow of a stimulus on the strips or wires.

In some examples, heat conducting strips of heat conducting strips or wires 616 are formed of at least one of a metal material, a ceramic material, or a metal-ceramic composite material.

### Example Process Flows

FIG. 7 illustrates an example process flow 700 that can facilitate auto-correction of antenna geometry using metamaterials, in accordance with an embodiment of this disclosure. In some examples, one or more embodiments of process flow 700 can be implemented by auto-correction of antenna geometry using metamaterials component 112 of FIG. 1, or computing environment 1300 of FIG. 13.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 800 of FIG. 8, process flow 900 of FIG. 9, process flow 1000 of FIG. 10, process flow 1100 of FIG. 11, and/or process flow 1200 of FIG. 12.

Process flow 700 begins with 702, and moves to operation 704.

Operation 704 depicts detecting a measure of performance of an antenna. In some examples, operation 704 can be implemented by antenna performance detector 204 of FIG. 2.

In some examples, the antenna comprises a bilayer material, and wherein a bilayer curvature of the antenna ranges between about 0.1 and about 0.5 millimeters. That is, in some examples, bilateral curvature (κ) can range from about 0.1-0.5 millimeters.

In some examples, a thickness of the antenna ranges between about 0.5 and about 1.5 millimeters. In some examples, a curvature of the antenna is at most about 1.5 millimeters.

In some examples, the measure of performance comprises an output level of the antenna. That is, a KPI used an be an antenna dB output.

After operation 704, process flow 700 moves to operation 706.

Operation 706 depicts determining an amount of an external stimulus with which to stimulate the antenna based on the measure of performance. In some examples, operation 706 can be implemented by distortion correction component 206 of FIG. 2.

After operation 706, process flow 700 moves to operation 708.

Operation 708 depicts stimulating the antenna with the amount of the external stimulus. In some examples, operation 706 can be implemented by distortion correction component 206 of FIG. 2.

In some examples, the antenna is configured to change, independently of increasing an amount of power to the antenna, from a first shape to a second shape in response to being stimulated with the external stimulus, and wherein a second performance of the antenna that corresponds to the second shape is greater, according to a defined performance metric, than a first performance of the antenna that corresponds to the first shape. That is, performance of the antenna can be improved without increasing power to antenna used to broadcast a signal.

After operation 708, process flow 700 moves to 710, where process flow 700 ends.

FIG. 8 illustrates an example process flow 800 that can facilitate auto-correction of antenna geometry using metamaterials, in accordance with an embodiment of this disclosure. In some examples, one or more embodiments of process flow 800 can be implemented by auto-correction of antenna geometry using metamaterials component 112 of FIG. 1, or computing environment 1300 of FIG. 13.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 700 of FIG. 7, process flow 900 of FIG. 9, process flow 1000 of FIG. 10, process flow 1100 of FIG. 11, and/or process flow 1200 of FIG. 12.

Process flow 800 begins with 802, and moves to operation 804.

Operation 804 depicts determining an amount of an external stimulus with which to stimulate an antenna based on a measure of performance and based on an indication of a physical environmental condition of a physical environment in which the antenna is located. That is, in some examples, a distortion correction component can factor environmental conditions into its decision on whether and how to provide an external stimulus to an antenna. Environmental conditions can include metrics such as an ambient temperature of the environment. In some examples, these environmental conditions can be considered in addition to, or instead of, performance metrics of the antenna.

After operation 804, process flow 800 moves to operation 806.

Operation 806 depicts stimulating the antenna with the amount of the external stimulus. In some examples, operation 806 can be implemented in a similar manner as operation 708 of FIG. 7.

After operation 806, process flow 800 moves to 808, where process flow 800 ends.

FIG. 9 illustrates an example process flow 900 that can facilitate auto-correction of antenna geometry using metamaterials, in accordance with an embodiment of this disclosure. In some examples, one or more embodiments of process flow 900 can be implemented by auto-correction of antenna geometry using metamaterials component 112 of FIG. 1, or computing environment 1300 of FIG. 13.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 700 of FIG. 7, process flow 800 of FIG. 8, process flow 1000 of FIG. 10, process flow 1100 of FIG. 11, and/or process flow 1200 of FIG. 12.

Process flow 900 begins with 902, and moves to operation 904.

Operation 904 depicts determining a performance of an antenna, wherein a shape of the antenna changes shape in response to application of a stimulus to the antenna. In some examples, operation 904 can be implemented in a similar manner as operation 704 of FIG. 7.

In some examples, the antenna becomes distorted based on an external environmental factor, and the external environmental factor comprises a temperature, a humidity, or a physical trauma to the antenna caused by an environment in which the antenna exists. That is, environmental reasons can account for why an antenna's physical shape has become distorted, and therefore has a reduced performance metric relative to its performance metric while in an intended, original, or previous physical shape.

After operation 904, process flow 900 moves to operation 906.

Operation 906 depicts determining an amount of the stimulus to apply to the antenna based on the performance. In some examples, operation 906 can be implemented in a similar manner as operation 706 of FIG. 7.

After operation 906, process flow 900 moves to operation 908.

Operation 908 depicts applying the amount of the stimulus to the antenna. In some examples, operation 908 can be implemented in a similar manner as operation 708 of FIG. 7.

After operation 908, process flow 900 moves to 910, where process flow 900 ends.

FIG. 10 illustrates an example process flow 1000 that can facilitate auto-correction of antenna geometry using metamaterials, in accordance with an embodiment of this disclosure. In some examples, one or more embodiments of process flow 1000 can be implemented by auto-correction of antenna geometry using metamaterials component 112 of FIG. 1, or computing environment 1300 of FIG. 13.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 700 of FIG. 7, process flow 800 of FIG. 8, process flow 900 of FIG. 9, process flow 1100 of FIG. 11, and/or process flow 1200 of FIG. 12.

Process flow 1000 begins with 1002, and moves to operation 1004.

Operation 1004 depicts determining that a performance satisfies a threshold value criterion. This threshold value criterion can indicate whether antenna performance has degraded sufficiently that a corrective stimulus will be applied. That is, an antenna KPI detector can issue alerts regarding changes above a certain threshold, and in response to receiving such an alert, a distortion correction component can correct a distortion in the antenna. Expressed another way, it can be that the antenna is stimulated with the stimulus when the antenna's performance has degraded beyond a threshold amount.

After operation 1004, process flow 1000 moves to operation 1006.

Operation 1006 depicts applying an amount of a stimulus to an antenna in response to determining that the performance satisfies the threshold value criterion. In some examples, operation 1006 can be implemented in a similar manner as operation 908 of FIG. 9.

After operation 1006, process flow 1000 moves to 1008, where process flow 1000 ends.

FIG. 11 illustrates an example process flow 1100 that can facilitate auto-correction of antenna geometry using metamaterials, in accordance with an embodiment of this disclosure. In some examples, one or more embodiments of process flow 1100 can be implemented by auto-correction of antenna geometry using metamaterials component 112 of FIG. 1, or computing environment 1300 of FIG. 13.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 700 of FIG. 7, process flow 800 of FIG. 8, process flow 900 of FIG. 9, process flow 1000 of FIG. 10, and/or process flow 1200 of FIG. 12.

Process flow 1100 begins with 1102, and moves to operation 1104.

Operation 1104 depicts determining to apply a stimulus to the antenna. In some examples, operation 1104 can be performed by antenna performance detector 204 of FIG. 2.

After operation 1104, process flow 1100 moves to operation 1106.

Operation 1106 depicts heating a layer of the antenna based on a mismatch in respective thermal expansion coefficients of respective layers of a bilayer material of the antenna, wherein the antenna is configured to bend in response to the amount of the heat being applied. In some examples, operation 1106 can be performed by distortion correction component 206 of FIG. 2.

That is, a distortion correction component can correct distortion by outputting a correction pulse, which can the stimulate an antenna layer depending on Ja (the mismatch in the thermal expansion coefficients) to get the antenna to bend in an intended direction.

After operation 1106, process flow 1100 moves to 1108, where process flow 1100 ends.

FIG. 12 illustrates an example process flow 1200 that can facilitate auto-correction of antenna geometry using metamaterials, in accordance with an embodiment of this disclosure. In some examples, one or more embodiments of process flow 1200 can be implemented by auto-correction of antenna geometry using metamaterials component 112 of FIG. 1, or computing environment 1300 of FIG. 13.

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of one or more of process flow 700 of FIG. 7, process flow 800 of FIG. 8, process flow 900 of FIG. 9, process flow 1000 of FIG. 10, and/or process flow 1100 of FIG. 11.

Process flow 1200 begins with 1202, and moves to operation 1204.

Operation 1204 depicts determining a signal wavelength that an antenna is able to detect. That is, a programmable antenna according to the present techniques can possess dynamic characteristics, which can be optimized to receive different wavelengths, and thus decrease a possibility of signal loss. That is, signal loss can be mitigated or avoided by altering an antenna to receive a particular signal. In such examples, operation 1204 can comprise determining which signal wavelength that a shape of the antenna is to be modified so that the antenna can receive that signal wavelength.

After operation 1204, process flow 1200 moves to operation 1206.

Operation 1206 depicts applying the amount of the stimulus to the antenna, comprising configuring the antenna to detect signals according to the signal wavelength. In some examples, operation 1106 can be performed by distortion correction component 206 of FIG. 2, where distortion correction component 206 can determine a shape of the antenna where the antenna is configured to receive signals at the signal wavelength, determine an amount of stimulus to provide to the antenna to cause it to take the shape, and apply that amount of stimulus to the antenna.

After operation 1206, process flow 1200 moves to 1208, where process flow 1200 ends.

### Example Operating Environment

In order to provide additional context for various embodiments described herein, FIG. 13 and the following discussion are intended to provide a brief, general description of a suitable computing environment 1300 in which the various embodiments of the embodiment described herein can be implemented.

For example, parts of computing environment 1300 can be used to implement one or more embodiments of antenna KPI detector 106 and/or distortion correction component 108 of FIG. 1.

In some examples, computing environment 1300 can implement one or more embodiments of the process flows of FIGS. 7-12 to facilitate auto-correction of antenna geometry using metamaterials.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a nonvolatile storage such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), one or more external storage devices 1316 (e.g., a magnetic floppy disk drive (FDD) 1316, a memory stick or flash drive reader, a memory card reader, etc.) and an optical disk drive 1320 (e.g., which can read or write from a CD-ROM disc, a DVD, a BD, etc.). While the internal HDD 1314 is illustrated as located within the computer 1302, the internal HDD 1314 can also be configured for external use in a suitable chassis (not shown). Additionally, while not shown in environment 1300, a solid state drive (SSD) could be used in addition to, or in place of, an HDD 1314. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enable with a security module, such as a trusted processing module (TPM). For instance, with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are example and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a communications antenna comprising a material that is configured to change shape in response to being stimulated with an external stimulus;
an antenna performance detector that is configured to detect a measure of performance of the communications antenna; and
a distortion correction component that is configured to:
receive an indication of the measure of performance,
determine an amount of distortion of the shape of the communications antenna based on the indication of the measure of performance,
based on the amount of distortion, determine an amount of the external stimulus with which to stimulate the communications antenna, and
selectively apply the amount of the external stimulus to the communications antenna to change the shape of the communications antenna.

2. The system of claim 1, wherein the indication of the measure of performance is a first indication of a first measure of performance, wherein selectively applying the amount of the external stimulus to the communications antenna to change the shape of the communications antenna produces a first antenna shape, wherein the amount of distortion is a first amount of distortion, wherein the amount of the external stimulus is a first amount of the external stimulus, and wherein the distortion correction component is further configured to:
receive a second indication of a second measure of performance, the second measure of performance being based on the first indication of the first measure of performance,
determine a second amount of distortion of the first antenna shape of the communications antenna based on the second indication of the second measure of performance,
based on the second amount of distortion, determine a second amount of the external stimulus with which to stimulate the communications antenna, and
selectively apply the second amount of the external stimulus to the communications antenna to change the shape of the communications antenna from the first antenna shape to a second antenna shape.

3. The system of claim 1, wherein the distortion correction component is further configured to:
stimulate respective locations of a group of locations of the communications antenna with the amount of the external stimulus;
select a location of the group of locations based on the indication of the measure of performance; and
stimulate the communications antenna with the amount of the external stimulus at the location.

4. The system of claim 1, wherein the external stimulus comprises the heat energy, and further comprising:
a heat sink of a distributed unit of a radio that is communicatively coupled to the communications antenna,
wherein the distortion correction component is further configured to acquire the amount of heat energy from the heat sink.

5. The system of claim 4, further comprising:
a group of heat conducting strips or wires coupled to the heat sink, wherein respective heat conducting strips or wires of the group of heat conducting strips or wires are configured to carry the heat energy from the heat sink to respective locations on the communications antenna.

6. The system of claim 5, further comprising:
a group of electronic switches, wherein respective electronic switches of the group of electronic switches are configured to selectively control whether the respective heat conducting strips or wires carry the heat energy from the heat sink to the respective locations on the communications antenna.

7. The system of claim 5, wherein the group of heat conducting strips are formed of at least one of:
a metal material, a ceramic material, or a metal-ceramic composite material.

8. The system of claim 1, wherein the communications antenna comprises a bilayer material, and wherein changing the shape of the communications antenna comprises changing a bilayer curvature of the communications antenna.

9. A method, comprising:
detecting, by a system comprising a processor, a measure of performance of an antenna;
determining, by the system, an amount of an external stimulus with which to stimulate the antenna based on the measure of performance; and
stimulating, by the system, the antenna with the amount of the external stimulus.

10. The method of claim 5, wherein the antenna comprises a bilayer material, and wherein a bilayer curvature of the antenna ranges between about 0.1 and about 0.5 millimeters.

11. The method of claim 5, wherein a thickness of the antenna ranges between about 0.5 and about 1.5 millimeters.

12. The method of claim 5, wherein a curvature of the antenna is at most about 1.5 millimeters.

13. The method of claim 5, wherein the measure of performance comprises an output level of the antenna.

14. The method of claim 5, wherein determining the amount of the external stimulus with which to stimulate the antenna based on the measure of performance comprises:
determining the amount of the external stimulus with which to stimulate the antenna based on the measure of performance and based on an indication of a physical environmental condition of a physical environment in which the antenna is located.

15. The method of claim 5, wherein the antenna is configured to change, independently of increasing an amount of power to the antenna, from a first shape to a second shape in response to being stimulated with the external stimulus, and wherein a second performance of the antenna that corresponds to the second shape is greater, according to a defined performance metric, than a first performance of the antenna that corresponds to the first shape.

16. A non-transitory computer-readable medium comprising instructions that, in response to execution, cause a system comprising a processor to perform operations, comprising:
determining a performance of an antenna, wherein a shape of the antenna changes shape in response to application of a stimulus to the antenna;
determining an amount of the stimulus to apply to the antenna based on the performance; and
applying the amount of the stimulus to the antenna.

17. The non-transitory computer-readable medium of claim 12, wherein the antenna becomes distorted based on an external environmental factor, and wherein the external environmental factor comprises a temperature, a humidity, or a physical trauma to the antenna caused by an environment in which the antenna exists.

18. The non-transitory computer-readable medium of claim 12, wherein applying the amount of the stimulus comprises:
applying the amount of the stimulus to the antenna in response to determining that the performance satisfies a threshold value criterion.

19. The non-transitory computer-readable medium of claim 12, wherein the stimulus is heat, and wherein applying the amount of the stimulus comprises:
heating a layer of the antenna based on a mismatch in respective thermal expansion coefficients of respective layers of a bilayer material of the antenna, wherein the antenna is configured to bend in response to the amount of the heat being applied.

20. The non-transitory computer-readable medium of claim 12, wherein the operations further comprise:
determining a signal wavelength that the antenna is able to detect,
wherein applying the amount of the stimulus to the antenna comprises configuring the antenna to detect signals according to the signal wavelength.
